(19) United States
(12) Patent Application Publication
(10) Pub. No.: US 2024/0155420 A1
(43) Pub. Date: May 9, 2024

(54) CONFIGURATION FOR ASYMMETRIC QUALITY OF SERVICE (QOS) FLOWS

(71) Applicant: QUALCOMM INCORPORATED, San Diego, CA (US)

(72) Inventors: Kefeng ZHANG, Beijing (CN); Dario Serafino TONESI, San Diego, CA (US); Hong CHENG, Basking Ridge, NJ (US); Haris ZISIMOPOULOS, London (GB); Sebastian SPEICHER, Wallisellen (CH)

(21) Appl. No.: 18/549,755

(22) PCT Filed: Jun. 4, 2021
(86) PCT No.: PCT/CN2021/098327

§ 371 Date: Sep. 8, 2023

(51) Int. Cl. H04W 28/02; H04W 76/10

(52) U.S. Cl. CPC H04W 28/0268; H04W 76/10

(57) ABSTRACT

Methods, systems, and devices for wireless communication are described. In some wireless communications systems, a user equipment (UE) may establish a connection with a base station. The connection may correspond to one or more quality of service (QoS) flows for communications between the UE and the base station. The base station may transmit a configuration for a QoS flow to the UE in response to establishing the connection. The configuration for the QoS flow may include a set of one or more parameters specific to a direction of the QoS flow. The UE and the base station may communicate data in the direction of the QoS flow in accordance with the set of one or more parameters.

### CROSS REFERENCE

The present application is a 371 national stage filing of International PCT Application No. PCT/CN2021/098327 by ZHANG et al. entitled “CONFIGURATION FOR ASYMMETRIC QUALITY OF SERVICE (QOS) FLOWS,” filed Jun. 4, 2021, which is assigned to the assignee hereof, and which is expressly incorporated by reference in its entirety herein.

### FIELD OF TECHNOLOGY

The following relates to wireless communication, including configuration for asymmetric quality of service (QoS) flows.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

A UE may establish a connection, such as a protocol data unit (PDU) session, with a base station to perform communications. The base station may route uplink and downlink data between the UE and a core network in accordance with the connection. The connection may correspond to one or more quality of service (QoS) flows for communicating the uplink and downlink data.

### SUMMARY

The described techniques relate to improved methods, systems, devices, and apparatuses that support configuration for asymmetric quality of service (QoS) flows. Generally, the described techniques provide for a network to configure a direction of a QoS flow for communications between a user equipment (UE) and a base station. The UE and the base station may establish a connection. The connection may correspond to one or more QoS flows for communications between the UE and the base station. For example, the connection may be an example of a protocol data unit (PDU) session. The network may determine a direction of each QoS flow corresponding to the connection. The direction may be unidirectional (e.g., uplink or downlink) or bidirectional (e.g., uplink and downlink). In some examples, the network may allocate radio resources in the QoS flow for the determined direction. The base station, or some other network entity in communication with the UE, may transmit control signaling to the UE to forward the configuration for the QoS flow from the network to the UE in response to establishing the connection. The configuration for the QoS flow may include a set of one or more parameters that may be specific to the determined direction of the QoS flow. The UE may determine the direction of the QoS flow based on the set of one or more parameters. The UE and the base station may communicate data in the direction of the QoS flow. By indicating a direction of a QoS flow, the network may reduce overhead and improve utilization of communication resources for QoS flows.

A method for wireless communication at a UE is described. The method may include establishing a connection with a base station, where the connection corresponds to a QoS flow for communications between the UE and the base station, receiving control signaling including a configuration for the QoS flow in response to establishing the connection, where the configuration includes a set of one or more parameters specific to a direction of the QoS flow, and communicating data in the direction of the QoS flow in accordance with the set of one or more parameters.

An apparatus for wireless communication at a UE is described. The apparatus may include a processor, memory coupled with the processor, and instructions stored in the memory. The instructions may be executable by the processor to cause the apparatus to establish a connection with a base station, where the connection corresponds to a QoS flow for communications between the UE and the base station, receive control signaling including a configuration for the QoS flow in response to establishing the connection, where the configuration includes a set of one or more parameters specific to a direction of the QoS flow, and communicate data in the direction of the QoS flow in accordance with the set of one or more parameters.

Another apparatus for wireless communication at a UE is described. The apparatus may include means for establishing a connection with a base station, where the connection corresponds to a QoS flow for communications between the UE and the base station, means for receiving control signaling including a configuration for the QoS flow in response to establishing the connection, where the configuration includes a set of one or more parameters specific to a direction of the QoS flow, and means for communicating data in the direction of the QoS flow in accordance with the set of one or more parameters.

A non-transitory computer-readable medium storing code for wireless communication at a UE is described. The code may include instructions executable by a processor to establish a connection with a base station, where the connection corresponds to a QoS flow for communications between the UE and the base station, receive control signaling including a configuration for the QoS flow in response to establishing the connection, where the configuration includes a set of one or more parameters specific to a direction of the QoS flow, and communicate data in the direction of the QoS flow in accordance with the set of one or more parameters.

In some examples of the method, apparatuses, and non-transitory computer-readable medium described herein, the set of one or more parameters includes a flow direction parameter configured to indicate the direction of the QoS flow.

In some examples of the method, apparatuses, and non-transitory computer-readable medium described herein, the set of one or more parameters includes a QoS identifier (ID) for the QoS flow and the method, apparatuses, and non-transitory computer-readable medium may include further operations, features, means, or instructions for determining the direction of the QoS flow based on a mapping between the QoS flow ID and a QoS flow characteristic configured to indicate the direction.

In some examples of the method, apparatuses, and non-transitory computer-readable medium described herein, receiving the control signaling may include operations, features, means, or instructions for receiving the control signaling based on establishing the connection with the base station, an establishment of the QoS flow, a modification of the QoS flow, or any combination thereof.

In some examples of the method, apparatuses, and non-transitory computer-readable medium described herein, the set of one or more parameters comprise a first guaranteed flow bit rate (GFBR), a first maximum flow bit rate (MFBR), or both specific to an uplink direction in the QoS flow, and a second GFBR, a second MFBR, or both specific to a downlink direction in the QoS flow, and communicating the data may include operations, features, means, or instructions for transmitting uplink data in the uplink direction of the QoS flow in accordance with the first GFBR, the first MFBR, or both and receiving downlink data in the downlink direction of the QoS flow in accordance with the second GFBR, the second MFBR, or both.

In some examples of the method, apparatuses, and non-transitory computer-readable medium described herein, the set of one or more parameters indicates a maximum data burst volume (MDBV) associated with the QoS flow, the MDBV corresponding to a bandwidth assumption for the QoS flow, and the first GFBR, the first MFBR, the second GFBR, the second MFBR, or any combination thereof override the bandwidth assumption.

In some examples of the method, apparatuses, and non-transitory computer-readable medium described herein, the set of one or more parameters indicates a GFBR of zero, an MFBR of zero, or both for one of an uplink direction or a downlink direction of the QoS flow, and the GFBR of zero, the MFBR of zero, or both for the one of the uplink direction or the downlink direction indicates the QoS flow may be a unidirectional QoS flow.

In some examples of the method, apparatuses, and non-transitory computer-readable medium described herein, the set of one or more parameters indicates a first MDBV for each direction of the QoS flow and a second MDBV specific to a first direction of the QoS flow, and communicating the data may include operations, features, means, or instructions for communicating the data in the first direction of the QoS flow in accordance with the second MDBV and communicating the data in a second direction of the QoS flow in accordance with the first MDBV, where the first MDBV may be a nominal value.

In some examples of the method, apparatuses, and non-transitory computer-readable medium described herein, the set of one or more parameters indicates the direction of the QoS flow is an uplink direction, and communicating the data may include operations, features, means, or instructions for transmitting uplink data in the uplink direction of the QoS flow in accordance with the set of one or more parameters.

In some examples of the method, apparatuses, and non-transitory computer-readable medium described herein, the set of one or more parameters indicates the direction of the QoS flow is a downlink direction, and communicating the data may include operations, features, means, or instructions for receiving downlink data in the downlink direction of the QoS flow in accordance with the set of one or more parameters.

In some examples of the method, apparatuses, and non-transitory computer-readable medium described herein, the set of one or more parameters indicates the QoS flow supports an uplink direction and a downlink direction, and communicating the data may include operations, features, means, or instructions for receiving downlink data in the downlink direction of the QoS flow in accordance with the set of one or more parameters and transmitting uplink data in the uplink direction of the QoS flow in accordance with the set of one or more parameters.

A method for wireless communication at a base station is described. The method may include establishing a connection with a UE, where the connection corresponds to a QoS flow for communications between the base station and the UE, transmitting, to the UE, control signaling including a configuration for the QoS flow in response to establishing the connection, where the configuration includes a set of one or more parameters specific to a direction of the QoS flow, and communicating data in the direction of the QoS flow in accordance with the set of one or more parameters.

An apparatus for wireless communication at a base station is described. The apparatus may include a processor, memory coupled with the processor, and instructions stored in the memory. The instructions may be executable by the processor to cause the apparatus to establish a connection with a UE, where the connection corresponds to a QoS flow for communications between the base station and the UE, transmit, to the UE, control signaling including a configuration for the QoS flow in response to establishing the connection, where the configuration includes a set of one or more parameters specific to a direction of the QoS flow, and communicate data in the direction of the QoS flow in accordance with the set of one or more parameters.

Another apparatus for wireless communication at a base station is described. The apparatus may include means for establishing a connection with a UE, where the connection corresponds to a QoS flow for communications between the base station and the UE, means for transmitting, to the UE, control signaling including a configuration for the QoS flow in response to establishing the connection, where the configuration includes a set of one or more parameters specific to a direction of the QoS flow, and means for communicating data in the direction of the QoS flow in accordance with the set of one or more parameters.

A non-transitory computer-readable medium storing code for wireless communication at a base station is described. The code may include instructions executable by a processor to establish a connection with a UE, where the connection corresponds to a QoS flow for communications between the base station and the UE, transmit, to the UE, control signaling including a configuration for the QoS flow in response to establishing the connection, where the configuration includes a set of one or more parameters specific to a direction of the QoS flow, and communicate data in the direction of the QoS flow in accordance with the set of one or more parameters.

In some examples of the method, apparatuses, and non-transitory computer-readable medium described herein, the set of one or more parameters includes a flow direction parameter configured to indicate the direction of the QoS flow.

In some examples of the method, apparatuses, and non-transitory computer-readable medium described herein, the set of one or more parameters includes a QoS ID for the QoS flow and the method, apparatuses, and non-transitory computer-readable medium may include further operations, features, means, or instructions for determining the direction of the QoS flow based on a mapping between the QoS flow ID and a QoS flow characteristic configured to indicate the direction.

In some examples of the method, apparatuses, and non-transitory computer-readable medium described herein, transmitting the control signaling may include operations, features, means, or instructions for transmitting the control signaling based on establishing the connection with the UE, an establishment of the QoS flow, a modification of the QoS flow, or any combination thereof.

In some examples of the method, apparatuses, and non-transitory computer-readable medium described herein, the set of one or more parameters comprises a first GFBR, a first MFBR, or both specific to an uplink direction in the QoS flow, and a second GFBR, a second MFBR, or both specific to a downlink direction in the QoS flow, and communicating the data may include operations, features, means, or instructions for receiving uplink data in the uplink direction of the QoS flow in accordance with the first GFBR, the first MFBR, or both and transmitting downlink data in the downlink direction of the QoS flow in accordance with the second GFBR, the second MFBR, or both.

In some examples of the method, apparatuses, and non-transitory computer-readable medium described herein, the set of one or more parameters indicates an MDBV associated with the QoS flow, the MDBV corresponding to a bandwidth assumption for the QoS flow, and the first GFBR, the first MFBR, the second GFBR, the second MFBR, or any combination thereof override the bandwidth assumption.

In some examples of the method, apparatuses, and non-transitory computer-readable medium described herein, the set of one or more parameters indicates a GFBR of zero, an MFBR of zero, or both for one of an uplink direction or a downlink direction of the QoS flow, and the GFBR of zero, the MFBR of zero, or both for the one of the uplink direction or the downlink direction indicates the QoS flow may be a unidirectional QoS flow.

In some examples of the method, apparatuses, and non-transitory computer-readable medium described herein, the set of one or more parameters indicates a first MDBV for each direction of the QoS flow and a second MDBV specific to a first direction of the QoS flow, and communicating the data may include operations, features, means, or instructions for communicating the data in the first direction of the QoS flow in accordance with the second MDBV and communicating the data in a second direction of the QoS flow in accordance with the first MDBV, where the first MDBV may be a nominal value.

In some examples of the method, apparatuses, and non-transitory computer-readable medium described herein, the set of one or more parameters indicates the direction of the QoS flow is an uplink direction, and communicating the data may include operations, features, means, or instructions for receiving uplink data in the uplink direction of the QoS flow in accordance with the set of one or more parameters.

In some examples of the method, apparatuses, and non-transitory computer-readable medium described herein, the set of one or more parameters indicates the direction of the QoS flow is a downlink direction, and communicating the data may include operations, features, means, or instructions for transmitting downlink data in the downlink direction of the QoS flow in accordance with the set of one or more parameters.

In some examples of the method, apparatuses, and non-transitory computer-readable medium described herein, the set of one or more parameters indicates the QoS flow supports an uplink direction and a downlink direction, and communicating the data may include operations, features, means, or instructions for receiving uplink data in the uplink direction of the QoS flow in accordance with the set of one or more parameters and transmitting downlink data in the downlink direction of the QoS flow in accordance with the set of one or more parameters.

### BRIEF DESCRIPTION OF THE DRAWINGS

FIG. 1 illustrates an example of a wireless communications system that supports configuration for asymmetric quality of service (QoS) flows in accordance with aspects of the present disclosure.

FIG. 2 illustrates an example of a wireless communications system that supports configuration for asymmetric QoS flows in accordance with aspects of the present disclosure.

FIG. 3 illustrates an example of a process flow that supports configuration for asymmetric QoS flows in accordance with aspects of the present disclosure.

FIGS. 4 and 5 show block diagrams of devices that support configuration for asymmetric QoS flows in accordance with aspects of the present disclosure.

FIG. 6 shows a block diagram of a communications manager that supports configuration for asymmetric QoS flows in accordance with aspects of the present disclosure.

FIG. 7 shows a diagram of a system including a device that supports configuration for asymmetric QoS flows in accordance with aspects of the present disclosure.

FIGS. 8 and 9 show block diagrams of devices that support configuration for asymmetric QoS flows in accordance with aspects of the present disclosure.

FIG. 10 shows a block diagram of a communications manager that supports configuration for asymmetric QoS flows in accordance with aspects of the present disclosure.

FIG. 11 shows a diagram of a system including a device that supports configuration for asymmetric QoS flows in accordance with aspects of the present disclosure.

FIGS. 12 through 14 show flowcharts illustrating methods that support configuration for asymmetric QoS flows in accordance with aspects of the present disclosure.

### DETAILED DESCRIPTION

In some wireless communication systems, a base station or some other network entity may be part of a radio access network (RAN). The RAN may communicate with a set of user equipments (UEs). That is, the RAN (e.g., the base station) may route packets between the UE and a core network (also referred to as a “core data network”). A UE may establish a connection with the base station to communicate data with the core network. In some cases, the connection may correspond to one or more quality of service (QoS) flows for communicating the data between the UE and the core network. For some applications, such as low latency or time sensitive data traffic, the UE may communicate unidirectional data traffic or asymmetric bidirectional data traffic, where uplink data traffic may correspond to different communication parameters than downlink data traffic. However, the network may allocate bidirectional (e.g., uplink and downlink) radio resources for each QoS flow, and each QoS flow may be configured with the same parameters for uplink and downlink data traffic irrespective of whether the QoS flow will be used by the UE for unidirectional or asymmetric data traffic. Such bidirectional QoS flow configurations may result in increased overhead and unused communication resources.

To more efficiently allocate radio resources for QoS flows, a control plane function of the core network may specify separate QoS flow configurations for different QoS flow directions. For example, the control plane may indicate a configured direction for each QoS flow. The base station may receive the indication of the direction and allocate radio resources for the QoS flow in the indicated direction. The direction may be unidirectional (e.g., uplink or downlink) or bidirectional (e.g., uplink and downlink). The base station may transmit a configuration for the QoS flow to a UE when the UE establishes a connection with the network, when a QoS flow is modified, when a new QoS flow is established, or any combination thereof. The direction may be signaled via a QoS parameter for the QoS flow. Alternatively, the base station may indicate a QoS identifier (ID) for the QoS flow, and the UE may determine the direction based on a mapping between the QoS ID and a configured flow direction characteristic for the QoS flow.

The control plane function may configure different guaranteed flow bit rate (GFBR) or maximum flow bit rate (MFBR) values for uplink and downlink data traffic in the QoS flow. The control plane function may additionally or alternatively configure a maximum data burst volume (MDBV) value for the uplink data traffic, the downlink data traffic, or both in the QoS flow. The configured MDBV for the uplink or downlink may be different from a nominal MDBV value for the QoS flow (e.g., for a bidirectional QoS flow), and the UE may use the nominal MDBV value for communicating in the direction that was not configured with the MDBV. Accordingly, devices in a wireless communications system may support asymmetric bidirectional QoS flows that include different communication parameters for each direction in the QoS flow.

Aspects of the disclosure are initially described in the context of wireless communications systems. Additional aspects are described with reference to process flows. Aspects of the disclosure are further illustrated by and described with reference to apparatus diagrams, system diagrams, and flowcharts that relate to configuration for asymmetric QoS flows.

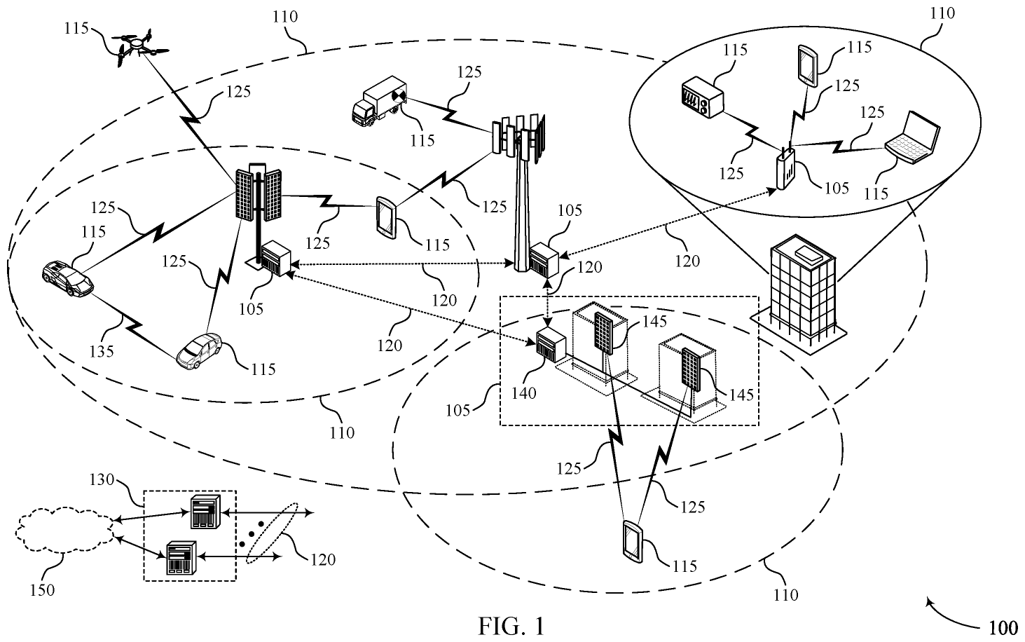

FIG. 1 illustrates an example of a wireless communications system 100 that supports configuration for asymmetric QoS flows in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some examples, a control plane function of the core network 130 may configure a direction of a QoS flow for communications between a UE 115 and a base station 105. The UE 115 and the base station 105 may establish a connection corresponding to one or more QoS flows for communications between the UE 115 and the base station 105. For example, the connection may be an example of a PDU session. The core network 130 may determine a direction of each QoS flow corresponding to the connection. The direction may be unidirectional (e.g., uplink or downlink) or bidirectional (e.g., uplink and downlink). The core network 130 may indicate the direction to the RAN, and the RAN may allocate radio resources in the QoS flow for the determined direction. The base station 105 (e.g., or some other network entity that is part of the RAN) may transmit control signaling to the UE 115 to indicate a configuration for the QoS flow in response to establishing the connection. The configuration for the QoS flow may include a set of one or more parameters that may be specific to the determined direction of the QoS flow. The UE 115 may thereby determine the direction of the QoS flow based on the set of one or more parameters. The UE 115 and the base station 105 may communicate data in the direction of the QoS flow. By indicating a direction of a QoS flow and setting QoS parameters that are specific to flow direction, the network may reduce overhead and improve utilization of communication resources for QoS flows, particularly when one direction of traffic has higher or lower QoS requirements than another direction of traffic.

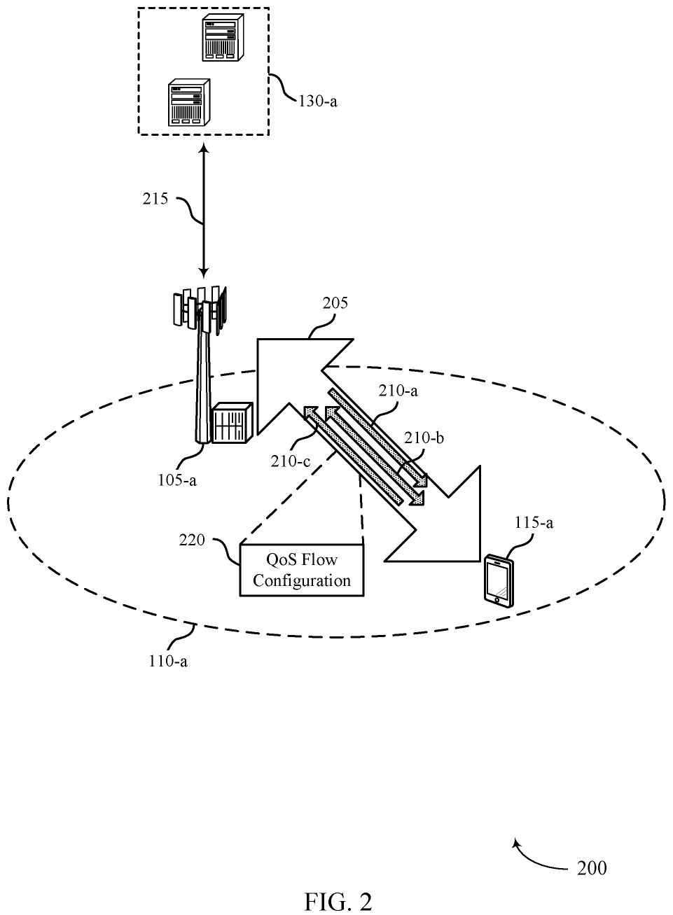

FIG. 2 illustrates an example of a wireless communications system 200 that supports configuration for asymmetric QoS flows in accordance with aspects of the present disclosure. The wireless communications system 200 may include a base station 105-a and a UE 115-a, which may represent examples of a base station 105 and a UE 115 as described with reference to FIG. 1. The base station 105-a may communicate with the UE 115-a via a communication link 205 within a geographic coverage area 110-a. The wireless communications system 200 may include a core network 130-a (e.g., a 5GC), which may be an example of a core network 130 as described with reference to FIG. 1. The core network 130-a may include one or more control plane and user plane entities (e.g., a UPF, or other user plane entities), as described with reference to FIG. 1.

The base station 105-a may be an example of a network entity that is part of a RAN, which may route data between the UE 115-a (e.g., and other UEs 115) and the core network 130-a (e.g., a data network). The base station 105-a may route data to and from the core network 130-a via the communication link 215 (e.g., a control plane interface, such as an N2 link). The UE 115-a may establish a connection with the base station 105-a to communicate with the core network 130-a. The connection may correspond to one or more QoS flows 210 for communicating data. For example, the connection may, in some examples, be a PDU session. In some cases, a QoS flow 210 may include a group of one or more service data flows for communications between the UE 115-a and the network 130-a that correspond to a same set of one or more QoS characteristics.

The core network 130-a may configure a QoS flow 210 or update a configuration for an existing QoS flow 210 when a PDU session or some other connection is established between the UE 115-a and the base station 105-a, when a PDU session is modified, when a PDU session is updated, or any combination thereof. The core network 130-a may signal the configuration for the QoS flow 210 to the base station 105-a (e.g., the RAN) via the communication link 215 (e.g., an N2 link). The base station 105-a may transmit control signaling via the communication link 205 to forward the QoS flow configuration 220 to the UE 115-a.

The QoS flow configuration 220 may configure each QoS flow 210 with a QoS ID, a set of QoS parameters, a set of QoS characteristics, or any combination thereof. In some cases, each QoS flow 210 may be configured for bidirectional traffic. For example, the QoS flow 210-b may be a bidirectional QoS flow 210-b. In such cases, the same QoS characteristics may be applied for uplink and downlink data traffic in each bidirectional QoS flow 210.

In some examples, however, the UE 115-a may support applications, such as time sensitive communications, industrial internet of things (IIoT), extended reality (XR), gaming, and other applications (e.g., interactive services with split rending, cloud, or edge, or other vertical applications) that correspond to asymmetric uplink and downlink data. That is, uplink data traffic for some applications may be associated with different communication parameters (e.g., latency, error rate, bit rate, or the like) than downlink data traffic for the same application. Additionally or alternatively, some applications may correspond to data traffic communicated in a single direction. That is, one or more unidirectional data streams may be communicated between the UE 115-a and the network 130-a in one of the uplink or downlink direction.

In some cases, to support such applications, the core network 130-a may configure a first bidirectional QoS flow 210 according to a first set of QoS characteristics for the uplink data and a second bidirectional QoS flow 210 according to a second set of QoS characteristics for the downlink data. That is, the core network 130-a may allocate different QoS flows 210 separately for uplink and downlink traffic (e.g., to efficiently utilize radio resources). In some cases, the core network 130-a may map a unidirectional data stream to a bidirectional QoS flow 210. The core network 130-a may indicate an intended direction of communications for a respective bidirectional QoS flow 210 to the RAN, and the RAN may allocate radio resources for the indicated direction within the bidirectional QoS flow 210. The RAN may refrain from allocating resources for the direction that is not indicated within the bidirectional QoS flow 210. Thus, some resources may be unused (e.g., wasted) within each bidirectional QoS flow 210.

To support applications associated with unidirectional or asymmetric data traffic, the core network 130-a as described herein may allocate a unidirectional or asymmetric QoS flow 210. The core network 130-a may signal, to the base station 105-a (e.g., via an N2 interface), a configuration for the QoS flow 210 that includes a set of one or more parameters specific to the direction of the QoS flow 210. The base station 105-a (e.g., or some other network entity that is part of the RAN) may enable resource allocation for the QoS flow 210 in the indicated direction based on the signaling. The base station 105-a may forward the QoS flow configuration 220 including the set of one or more parameters to the UE 115-a. Accordingly, a unidirectional or asymmetric QoS flow 210 may be configured, and unidirectional or asymmetric resource allocation may be enabled for the QoS flow 210. For example, the QoS flow 210-a may be configured as an uplink QoS flow 210-a, the QoS flow 210-c may be configured as a downlink QoS flow 210-c, and the QoS flow 210-b may be configured as an asymmetric bidirectional QoS flow 210-b. Uplink resources, downlink resources, and both uplink and downlink resources may be allocated for the QoS flows 210-a, 210-c, and 210-b, respectively, to provide for reduced overhead and more efficient utilization of resources.

In some examples, the flow direction may be indicated via a QoS parameter. That is, a flow direction QoS parameter may be configured to indicate a traffic direction of a QoS flow 210 (e.g., a bidirectional flow direction, an uplink flow direction, or a downlink flow direction). The traffic direction may be signaled to the RAN when a QoS flow 210 is established or modified, when the UE 115-a establishes a connection with the network 130-a (e.g., at UE context establishment), or both. The control plane of the core network 130-a may include a session management function (SMF). In some examples, the SMF may determine the flow direction parameter and signal the QoS flow direction parameter to the base station 105-a and a UPF or other user plane entity.

If a flow direction parameter is signaled for a QoS flow 210, the base station 105-a may enable unidirectional resource allocation for the respective QoS flow 210. The base station 105-a may forward the flow direction parameter to the UE 115-a via the QoS flow configuration 220. If a flow direction parameter is not signaled for a QoS flow 210, the flow direction may be assumed to be bidirectional (e.g., bidirectional may be a default or nominal flow direction).

In other examples, a QoS characteristic may be configured (e.g., defined) to indicate a flow direction for the QoS flow 210. The flow direction characteristic may be an optional parameter that may be set during configuration of a QoS flow 210. If the flow direction characteristic is not included in a configuration, or if a value of the flow direction characteristic is not set, the flow direction for the respective QoS flow 210 may be assumed to be bidirectional (e.g., a nominal or default flow direction).

The flow direction characteristic, and one or more other QoS characteristics for a respective QoS flow 210, may be determined by the base station 105-a, the UE 115-a, or both based on a mapping (e.g., a one-to-one mapping) between a QoS ID (e.g., a 5G QoS ID (5QI)) and the QoS characteristics. For example, a set of one or more QoS parameters indicated via the QoS flow configuration 220 may include the QoS ID, and each QoS ID value may correspond to a set of QoS characteristics, one or more of which may be configured to indicate a QoS flow direction. An example mapping between a QoS ID and a set of example QoS characteristics is illustrated in Table 1.

TABLE 1
Mapping Between QoS IDs and QoS Characteristics

| | | | | | | | | |
|---|---|---|---|---|---|---|---|---|
| 5QI | Resource | Default | Packet | Packet | Default | Default | Flow | Example |
| Value | Type | Priority | Delay | Error | Maximum Data | Averaging | Direction | Services |
| | | Level | Budget | Rate | Burst Volume | Window | | |

Although not illustrated in Table 1, the QoS ID value column may include any quantity of QoS ID values, corresponding to different rows in the table, and each of the QoS characteristic columns may include QoS characteristic values corresponding to the respective QoS ID. For example, a QoS ID value of one may be mapped to a first set of values for each of the QoS characteristics. Although the example mapping illustrated in Table 1 includes a mapping between a QoS ID and eight respective QoS characteristics, a QoS ID value may be mapped to any quantity of QoS characteristics, including the QoS characteristics shown in Table 1 and/or any other QoS characteristics not shown in Table 1.

In one example, the core network 130-a may configure a downlink direction for the QoS flow 210-a. The core network 130-a may signal a set of one or more parameters for the flow direction to the base station 105-a (e.g., the RAN). The set of one or more parameters may include a QoS ID for the QoS flow 210-a. The base station 105-a may forward the QoS flow configuration 220 including the set of one or more parameters to the UE 115-a. The base station 105-a and the UE 115-a may determine that the flow direction of the QoS flow 210-a is downlink based on a mapping, such as the mapping illustrated in Table 1, between the QoS ID and a flow direction characteristic configured to indicate the direction.

In some examples, the core network 130-a may configure an asymmetric QoS flow 210. That is, the core network 130-a may configure parameters or characteristics specific to an uplink direction in a bidirectional QoS flow 210 that are different from parameters or characteristics specific to a downlink direction in the QoS flow 210. For example, one or more bit rate parameters, such as a GFBR, an MFBR, or both may be configured specifically for uplink or downlink. In some examples, the SMF of the core network 130-a may receive an indication of policy and charging control (PCC) rules for data packets in the wireless communications system 200. The SMF may determine different GFBR values, MFBR values, or both for uplink and downlink data in a QoS flow 210 based on the PCC rules.

The core network 130-a (e.g., the SMF) may signal the GFBR and MFBR values to the base station 105-a via the QoS flow configuration 220. In some cases, a first QoS parameter may be configured to convey a GFBR for a QoS flow 210 and a second QoS parameter may be configured to convey an MFBR for a QoS flow 210. As described herein, third and fourth QoS parameters may be configured such that the QoS parameters may convey a first GFBR, a first MFBR, or both specific to an uplink direction in a QoS flow 210 and a second GFBR, a second MFBR, or both specific to a downlink direction in the QoS flow 210. The RAN may enable asymmetric radio resource allocation of the respective QoS flow 210 based on receiving the first and second GFBR and MFBR values. That is, a bidirectional QoS flow 210, such as the QoS flow 210-b, may be configured to support asymmetric data.

In some examples, a GFBR, an MFBR, or both may be set to zero bits per second for a direction. By setting the GFBR, the MFBR, or both to zero, the core network 130-a (e.g., the SMF) may indicate that a direction of the QoS flow 210 is unidirectional (e.g., an implicit indication of the QoS flow direction). The base station 105-a may allocate resources for the unidirectional QoS flow 210 accordingly.

In some cases, a single MDBV QoS characteristic, such as the MDBV characteristic illustrated in Table 1, may be configured for both uplink and downlink data in a QoS flow 210. The SMF may set the GFBR for some QoS flows 210, such as delay-critical guaranteed bit rate (GBR) QoS flows 210, such that the GFBR may be achieved with the MDBV characteristic that is configured for the QoS flow 210. As such, for some QoS flows 210, such as QoS flows 210 that support delay-critical GBR traffic, a relationship between the MDBV characteristic and a GFBR, an MFBR, or both may be considered. In such cases, if a GFBR, an MFBR, or both are signaled separately for uplink and downlink, a rule may be defined such that the GFBR and/or MFBR indicated for one or both directions may override a bandwidth assumption derived from the MDBV characteristic corresponding to the QoS ID value for the QoS flow 210.

In some examples, to support asymmetric QoS flows 210, one or more MDBV QoS characteristics may be configured to signal a customized MDBV value for a single direction. A nominal (e.g., pre-configured) MDBV value, such as the MDBV characteristic illustrated with respect to Table 1, may signal an MDBV value for uplink and downlink. The one or more additional MDBV characteristics may be configured such that a first MDBV characteristic may signal an MDBV for uplink data, a second MDBV characteristic may signal an MDBV for downlink data, or both. The core network 130-a (e.g., the SMF) may signal the MDBV characteristics to the base station 105-a to notify the RAN of the one or more MDBV values for radio access link layer protocol configurations. The base station 105-a and the UE 115-a may determine the MDBV characteristics based on a mapping between a QoS ID for a QoS flow 210 indicated via the QoS flow configuration 220 and the MDBV characteristics. For example, the mapping illustrated in Table 1 may be updated to include two or more MDBV characteristic values. The UE 115-a and the base station 105-a may communicate data in the indicated direction according to the signaled MDBV value(s). If an MDBV is not configured for a direction, the UE 115-a and the base station 105-a will, in some examples, communicate data in the direction according to the nominal (e.g., standard) MDBV value.

Accordingly, a core network 130-a may configure one or more QoS flows 210 with an uplink direction, a downlink direction, or both, such that radio resources may be allocated efficiently for the QoS flow 210. The core network 130-a may additionally or alternatively configure separate communication parameters for uplink and downlink directions in the QoS flow 210, to provide support for asymmetric data traffic in a QoS flow 210.

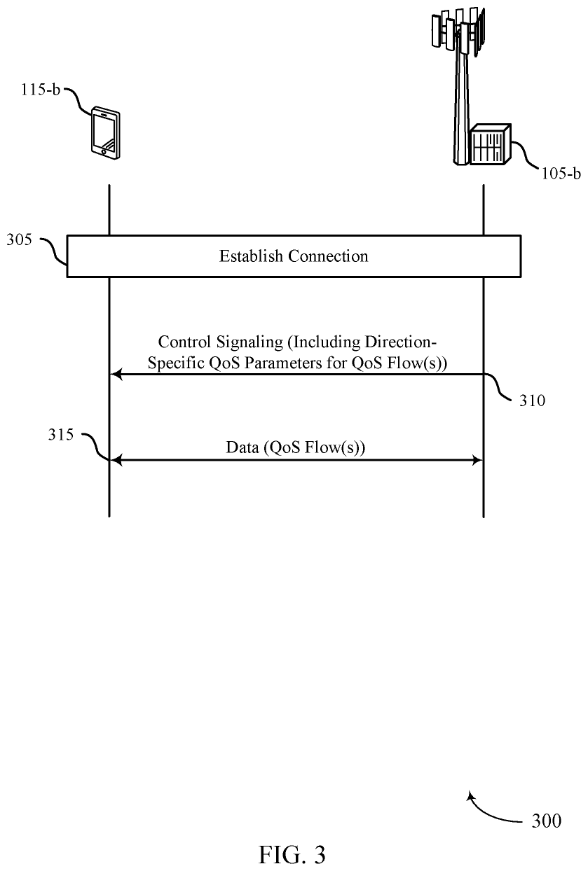

FIG. 3 illustrates an example of a process flow 300 that supports configuration for asymmetric QoS flows in accordance with aspects of the present disclosure. In some examples, the process flow 300 may implement various aspects of the present disclosure described with reference to FIGS. 1 and 2. The process flow 300 may include a UE 115-b and a base station 105-b, which may be examples of a UE 115 and a base station 105 as described with reference to FIGS. 1 and 2. In some examples, the base station 105-b may transmit a configuration for a QoS flow to the UE 115-b, and the configuration may include one or more parameters specific to a direction of the QoS flow.

It is understood that the devices and nodes described by the process flow 300 may communicate with or be coupled with other devices or nodes that are not illustrated. For example, the UE 115-b and the base station 105-b may communicate with one or more other UEs 115, base stations 105, or other devices. Alternative examples of the following may be implemented, where some steps are performed in a different order than described or are not performed at all. In some cases, a step may include additional features not mentioned below, or further steps may be added.

At 305, the UE 115-b and the base station 105-b may establish a connection. The connection may correspond to a QoS flow for communications between the UE 115-b and the base station 105-b. In some examples, the connection may be an example of a PDU session.

At 310, the base station 105-b may transmit control signaling to the UE 115-b. The control signaling may include a configuration for the QoS flow. The configuration may include a set of one or more parameters specific to a direction of the QoS flow. In some examples, the configuration may indicate direction-specific parameters for multiple QoS flows. The parameters may include a QoS ID, a flow direction parameter, one or more GFBR parameters, one or more MFBR parameters, other QoS parameters, or any combination thereof. A value of the QoS ID may be mapped to one or more QoS characteristics. The QoS characteristics may include a flow direction characteristic configured to indicate the direction of the QoS flow, one or more MDBV characteristics specific to a direction of the QoS flow, other QoS characteristics, or any combination thereof.

At 315, the UE 115-b and the base station 105-b may communicate data in the direction of the QoS flow in accordance with the set of one or more parameters. In some examples, the UE 115-b and the bases station 105-b may communicate in respective directions of one or more QoS flows. If the set of one or more parameters indicates the direction of the QoS flow is an uplink direction, the UE 115-b may transmit uplink data to the base station 105-b in the uplink direction of the QoS flow. If the set of one or more parameters indicates the direction of the QoS flow is a downlink direction, the base station 105-b may transmit downlink data to the UE 115-b in the downlink direction of the QoS flow. If the set of one or more parameters indicates the QoS flow supports an uplink direction and a downlink direction, the UE 115-b may transmit uplink data to the base station 105-b in the uplink direction of the QoS flow and the base station 105-b may transmit downlink data to the UE 115-b in the downlink direction of the QoS flow.

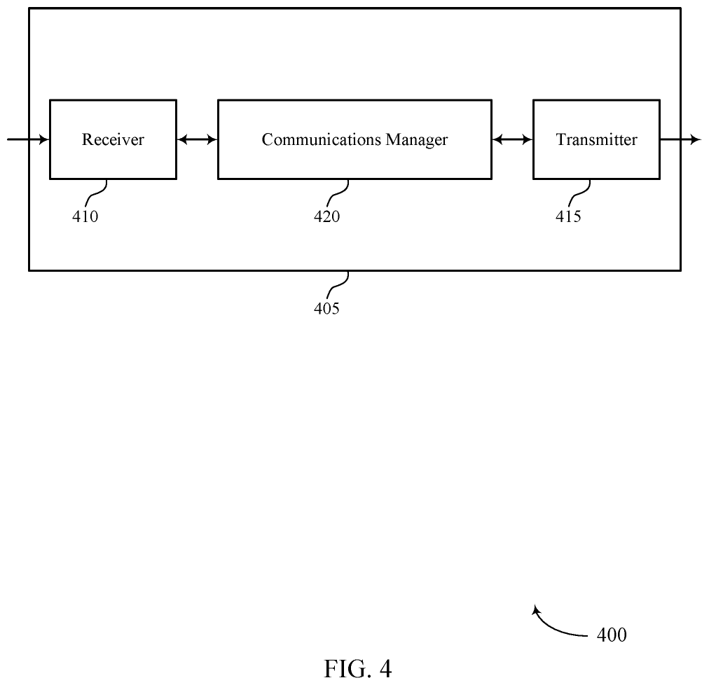

FIG. 4 shows a block diagram 400 of a device 405 that supports configuration for asymmetric QoS flows in accordance with aspects of the present disclosure. The device 405 may be an example of aspects of a UE 115 as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to configuration for asymmetric QoS flows). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to configuration for asymmetric QoS flows). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of configuration for asymmetric QoS flows as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 420 may be configured to perform various operations (e.g., receiving, monitoring, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to receive information, transmit information, or perform various other operations as described herein.

The communications manager 420 may support wireless communication at a UE in accordance with examples as disclosed herein. For example, the communications manager 420 may be configured as or otherwise support a means for establishing a connection with a base station, where the connection corresponds to a QoS flow for communications between the UE and the base station. The communications manager 420 may be configured as or otherwise support a means for receiving control signaling including a configuration for the QoS flow in response to establishing the connection, where the configuration includes a set of one or more parameters specific to a direction of the QoS flow. The communications manager 420 may be configured as or otherwise support a means for communicating data in the direction of the QoS flow in accordance with the set of one or more parameters.

By including or configuring the communications manager 420 in accordance with examples as described herein, the device 405 (e.g., a processor controlling or otherwise coupled to the receiver 410, the transmitter 415, the communications manager 420, or a combination thereof) may support techniques for reduced processing and more efficient utilization of communication resources. By supporting a QoS configuration that includes parameters specific to a direction of the QoS flow, the processor of the device 405 may support communication of asymmetric data traffic. Communicating asymmetric data traffic via a same QoS flow instead of different QoS flows may reduce processing and provide for more efficient utilization of communication resources.

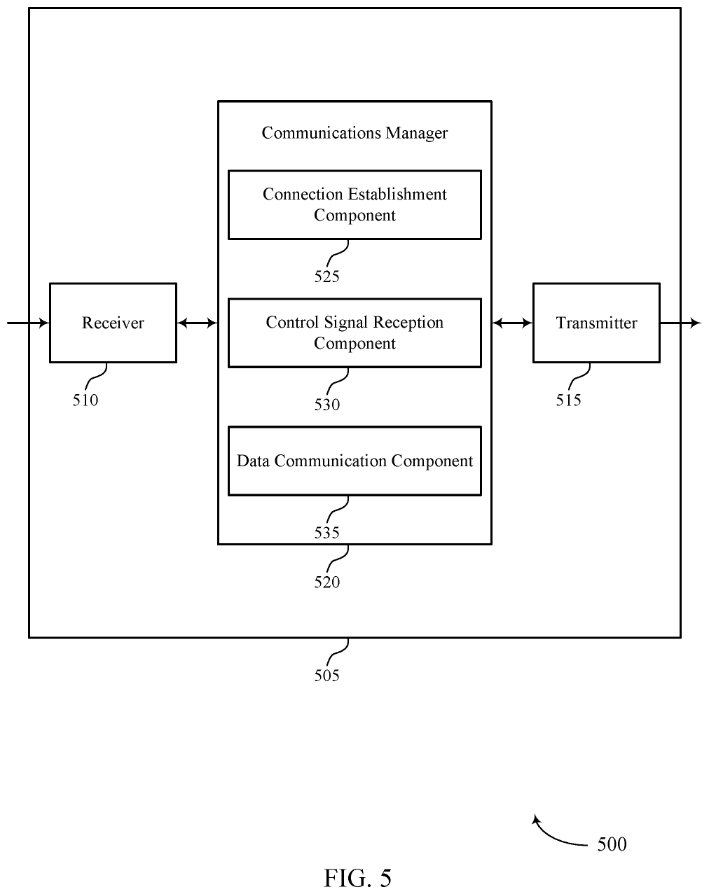

FIG. 5 shows a block diagram 500 of a device 505 that supports configuration for asymmetric QoS flows in accordance with aspects of the present disclosure. The device 505 may be an example of aspects of a device 405 or a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to configuration for asymmetric QoS flows). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to configuration for asymmetric QoS flows). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of configuration for asymmetric QoS flows as described herein. For example, the communications manager 520 may include a connection establishment component 525, a control signal reception component 530, a data communication component 535, or any combination thereof. The communications manager 520 may be an example of aspects of a communications manager 420 as described herein. In some examples, the communications manager 520, or various components thereof, may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communication at a UE in accordance with examples as disclosed herein. The connection establishment component 525 may be configured as or otherwise support a means for establishing a connection with a base station, where the connection corresponds to a QoS flow for communications between the UE and the base station. The control signal reception component 530 may be configured as or otherwise support a means for receiving control signaling including a configuration for the QoS flow in response to establishing the connection, where the configuration includes a set of one or more parameters specific to a direction of the QoS flow. The data communication component 535 may be configured as or otherwise support a means for communicating data in the direction of the QoS flow in accordance with the set of one or more parameters.

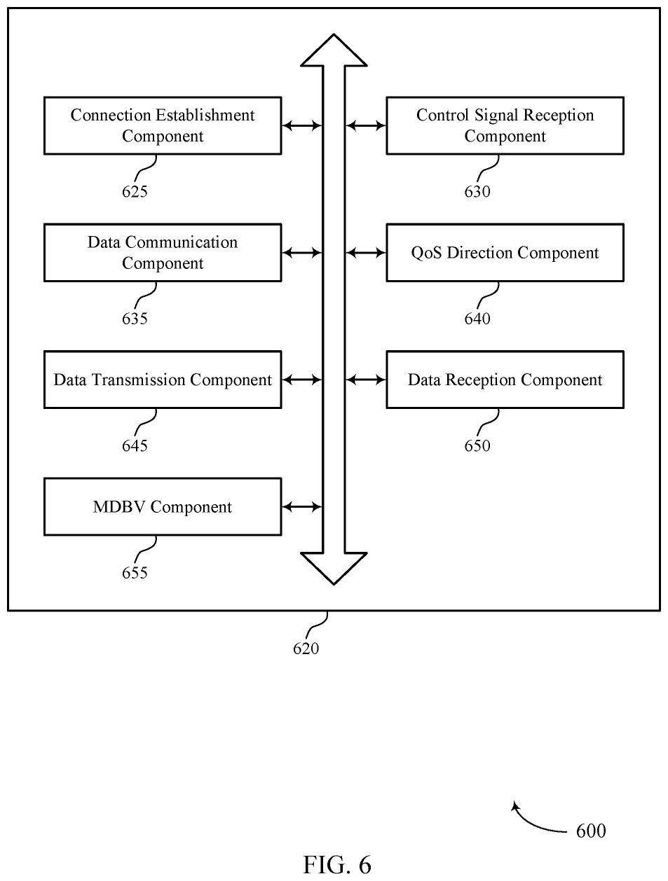

FIG. 6 shows a block diagram 600 of a communications manager 620 that supports configuration for asymmetric QoS flows in accordance with aspects of the present disclosure. The communications manager 620 may be an example of aspects of a communications manager 420, a communications manager 520, or both, as described herein. The communications manager 620, or various components thereof, may be an example of means for performing various aspects of configuration for asymmetric QoS flows as described herein. For example, the communications manager 620 may include a connection establishment component 625, a control signal reception component 630, a data communication component 635, a QoS direction component 640, a data transmission component 645, a data reception component 650, an MDBV component 655, or any combination thereof. Each of these components may communicate, directly or indirectly, with one another (e.g., via one or more buses).

The communications manager 620 may support wireless communication at a UE in accordance with examples as disclosed herein. The connection establishment component 625 may be configured as or otherwise support a means for establishing a connection with a base station, where the connection corresponds to a QoS flow for communications between the UE and the base station. The control signal reception component 630 may be configured as or otherwise support a means for receiving control signaling including a configuration for the QoS flow in response to establishing the connection, where the configuration includes a set of one or more parameters specific to a direction of the QoS flow. The data communication component 635 may be configured as or otherwise support a means for communicating data in the direction of the QoS flow in accordance with the set of one or more parameters.

In some examples, the set of one or more parameters includes a flow direction parameter configured to indicate the direction of the QoS flow. In some examples, the set of one or more parameters includes a QoS ID for the QoS flow, and the QoS direction component 640 may be configured as or otherwise support a means for determining the direction of the QoS flow based on a mapping between the QoS ID and a QoS flow characteristic configured to indicate the direction.

In some examples, to support receiving the control signaling, the connection establishment component 625 may be configured as or otherwise support a means for receiving the control signaling based on establishing the connection with the base station, an establishment of the QoS flow, a modification of the QoS flow, or any combination thereof.

In some examples, the set of one or more parameters comprise a first GFBR, a first MFBR, or both specific to an uplink direction in the QoS flow, and a second GFBR, a second MFBR, or both specific to a downlink direction in the QoS flow, and the data transmission component 645 may be configured as or otherwise support a means for transmitting uplink data in the uplink direction of the QoS flow in accordance with the first GFBR, the first MFBR, or both. In some examples, to support communicating the data, the data reception component 650 may be configured as or otherwise support a means for receiving downlink data in the downlink direction of the QoS flow in accordance with the second GFBR, the second MFBR, or both.

In some examples, the set of one or more parameters indicates a MDBV associated with the QoS flow, the MDBV corresponding to a bandwidth assumption for the QoS flow. In some examples, the first GFBR, the first MFBR, the second GFBR, the second MFBR, or any combination thereof override the bandwidth assumption.

In some examples, the set of one or more parameters indicates a GFBR of zero, an MFBR of zero, or both for one of an uplink direction or a downlink direction of the QoS flow. In some examples, the GFBR of zero, the MFBR of zero, or both for the one of the uplink direction or the downlink direction indicates the QoS flow is a unidirectional QoS flow.

In some examples, the set of one or more parameters indicates a first MDBV for each direction of the QoS flow and a second MDBV specific to a first direction of the QoS, and to support communicating the data, the MDBV component 655 may be configured as or otherwise support a means for communicating the data in the first direction of the QoS flow in accordance with the second MDBV. In some examples, to support communicating the data, the MDBV component 655 may be configured as or otherwise support a means for communicating the data in a second direction of the QoS flow in accordance with the first MDBV, where the first MDBV is a nominal value.

In some examples, the set of one or more parameters indicates the direction of the QoS is an uplink direction, and to support communicating the data, the data transmission component 645 may be configured as or otherwise support a means for transmitting uplink data in the uplink direction of the QoS flow in accordance with the set of one or more parameters.

In some examples, the set of one or more parameters indicates the direction of the QoS is a downlink direction, and to support communicating the data, the data reception component 650 may be configured as or otherwise support a means for receiving downlink data in the downlink direction of the QoS flow in accordance with the set of one or more parameters.

In some examples, the set of one or more parameters indicates the QoS supports an uplink direction and a downlink direction. In some examples, to support communicating the data, the data reception component 650 may be configured as or otherwise support a means for receiving downlink data in the downlink direction of the QoS flow in accordance with the set of one or more parameters. In some examples, to support communicating the data, the data transmission component 645 may be configured as or otherwise support a means for transmitting uplink data in the uplink direction of the QoS flow in accordance with the set of one or more parameters.

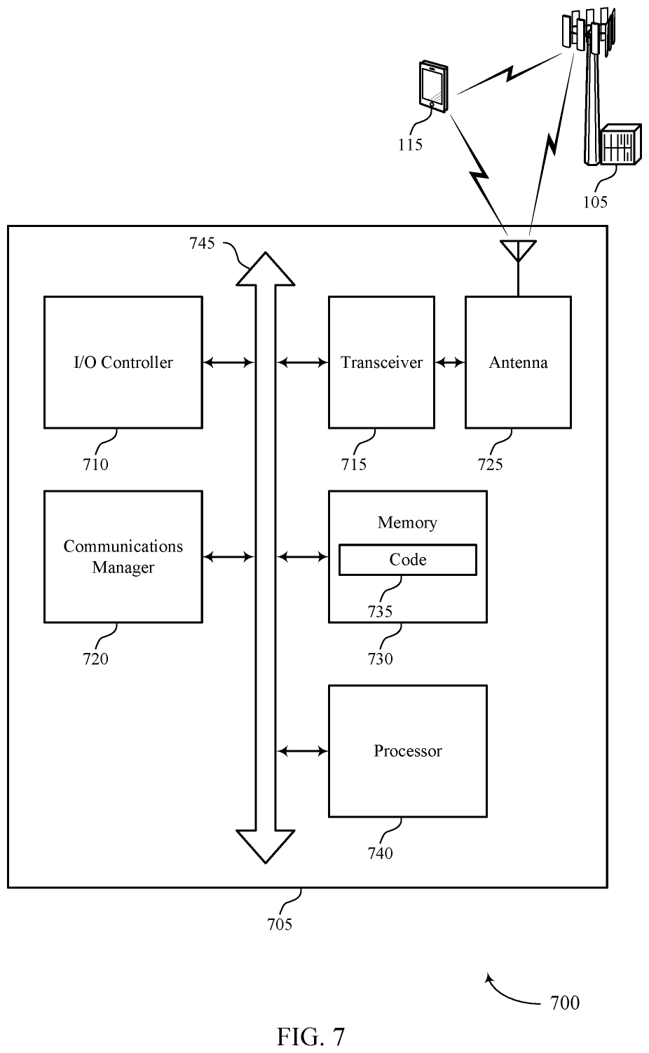

FIG. 7 shows a diagram of a system 700 including a device 705 that supports configuration for asymmetric QoS flows in accordance with aspects of the present disclosure. The device 705 may be an example of or include the components of a device 405, a device 505, or a UE 115 as described herein. The device 705 may communicate wirelessly with one or more base stations 105, UEs 115, or any combination thereof. The device 705 may include components for bidirectional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bidirectionally, via the one or more antennas 725, wired, or wireless links as described herein. For example, the transceiver 715 may represent a wireless transceiver and may communicate bidirectionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting configuration for asymmetric QoS flows). For example, the device 705 or a component of the device 705 may include a processor 740 and memory 730 coupled to the processor 740, the processor 740 and memory 730 configured to perform various functions described herein.

The communications manager 720 may support wireless communication at a UE in accordance with examples as disclosed herein. For example, the communications manager 720 may be configured as or otherwise support a means for establishing a connection with a base station, where the connection corresponds to a QoS flow for communications between the UE and the base station. The communications manager 720 may be configured as or otherwise support a means for receiving control signaling including a configuration for the QoS flow in response to establishing the connection, where the configuration includes a set of one or more parameters specific to a direction of the QoS flow. The communications manager 720 may be configured as or otherwise support a means for communicating data in the direction of the QoS flow in accordance with the set of one or more parameters.

By including or configuring the communications manager 720 in accordance with examples as described herein, the device 705 may support techniques for improved communication reliability, reduced latency, and more efficient utilization of communication resources. For example, by supporting asymmetric configurations for QoS flows, the device 705 may transmit and receive asymmetric data via a single QoS flow, which may reduce latency and provide for more efficient utilization of communication resources. Supporting asymmetric QoS flows may additionally or alternatively provide for improved communication reliability for applications associated with asymmetric data traffic. By receiving an indication of a direction of each QoS flow, the device 705 may support communication of unidirectional traffic via a unidirectional QoS flow, which may provide for a RAN to allocate radio resources in a single direction in the QoS flow. Such resource allocation may provide for more efficient utilization of communication resources.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of configuration for asymmetric QoS flows as described herein, or the processor 740 and the memory 730 may be otherwise configured to perform or support such operations.

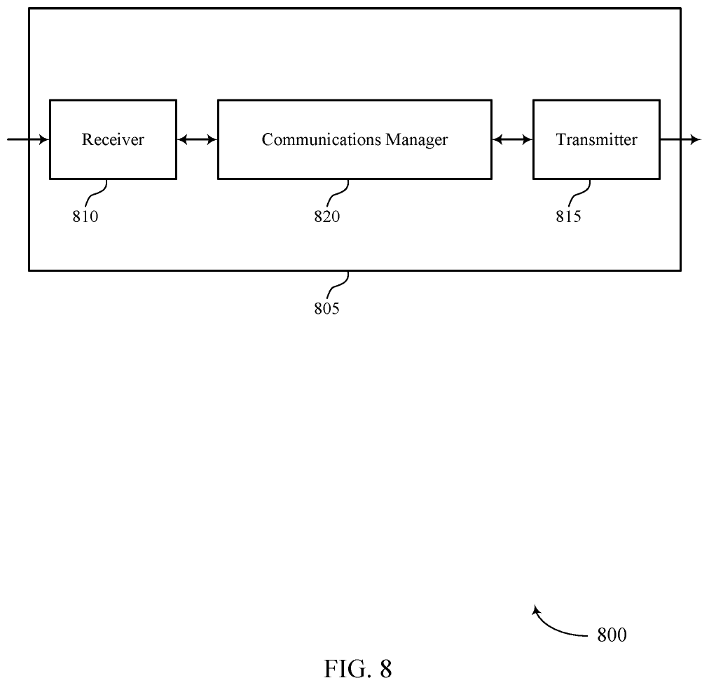

FIG. 8 shows a block diagram 800 of a device 805 that supports configuration for asymmetric QoS flows in accordance with aspects of the present disclosure. The device 805 may be an example of aspects of a base station 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to configuration for asymmetric QoS flows). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to configuration for asymmetric QoS flows). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of configuration for asymmetric QoS flows as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 820 may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The communications manager 820 may support wireless communication at a base station in accordance with examples as disclosed herein. For example, the communications manager 820 may be configured as or otherwise support a means for establishing a connection with a UE, where the connection corresponds to a QoS flow for communications between the base station and the UE. The communications manager 820 may be configured as or otherwise support a means for transmitting, to the UE, control signaling including a configuration for the QoS flow in response to establishing the connection, where the configuration includes a set of one or more parameters specific to a direction of the QoS flow. The communications manager 820 may be configured as or otherwise support a means for communicating data in the direction of the QoS flow in accordance with the set of one or more parameters.

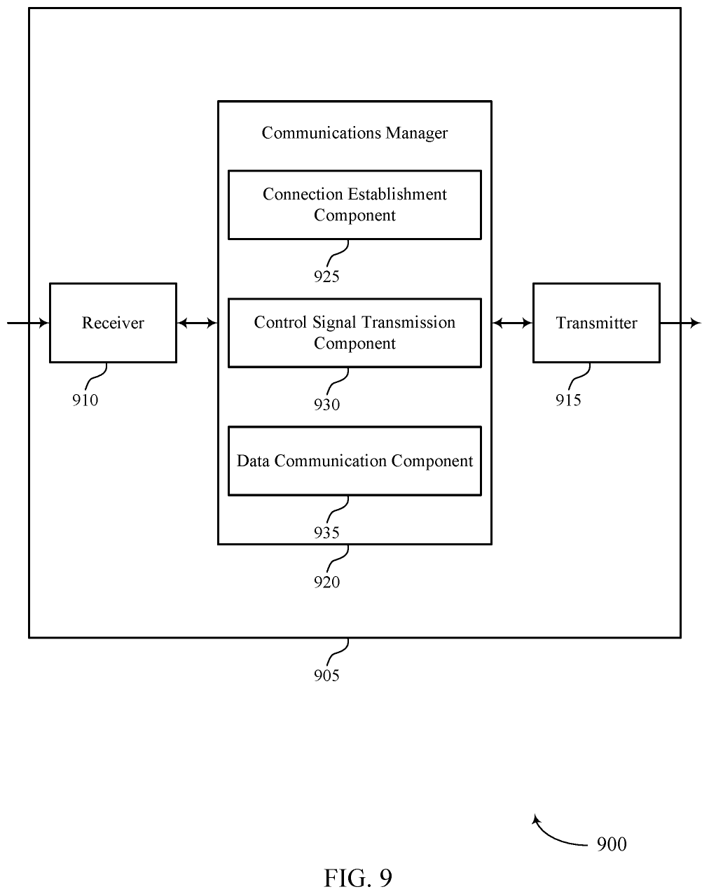

FIG. 9 shows a block diagram 900 of a device 905 that supports configuration for asymmetric QoS flows in accordance with aspects of the present disclosure. The device 905 may be an example of aspects of a device 805 or a base station 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to configuration for asymmetric QoS flows). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to configuration for asymmetric QoS flows). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of configuration for asymmetric QoS flows as described herein. For example, the communications manager 920 may include a connection establishment component 925, a control signal transmission component 930, a data communication component 935, or any combination thereof. The communications manager 920 may be an example of aspects of a communications manager 820 as described herein. In some examples, the communications manager 920, or various components thereof, may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communication at a base station in accordance with examples as disclosed herein. The connection establishment component 925 may be configured as or otherwise support a means for establishing a connection with a UE, where the connection corresponds to a QoS flow for communications between the base station and the UE. The control signal transmission component 930 may be configured as or otherwise support a means for transmitting, to the UE, control signaling including a configuration for the QoS flow in response to establishing the connection, where the configuration includes a set of one or more parameters specific to a direction of the QoS flow. The data communication component 935 may be configured as or otherwise support a means for communicating data in the direction of the QoS flow in accordance with the set of one or more parameters.

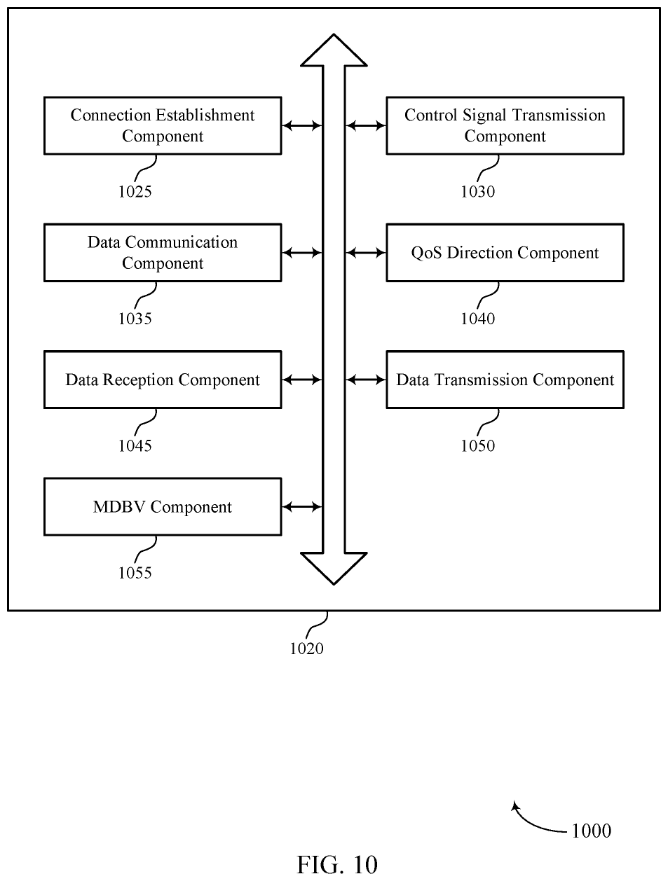

FIG. 10 shows a block diagram 1000 of a communications manager 1020 that supports configuration for asymmetric QoS flows in accordance with aspects of the present disclosure. The communications manager 1020 may be an example of aspects of a communications manager 820, a communications manager 920, or both, as described herein. The communications manager 1020, or various components thereof, may be an example of means for performing various aspects of configuration for asymmetric QoS flows as described herein. For example, the communications manager 1020 may include a connection establishment component 1025, a control signal transmission component 1030, a data communication component 1035, a QoS direction component 1040, a data reception component 1045, a data transmission component 1050, an MDBV component 1055, or any combination thereof. Each of these components may communicate, directly or indirectly, with one another (e.g., via one or more buses).

The communications manager 1020 may support wireless communication at a base station in accordance with examples as disclosed herein. The connection establishment component 1025 may be configured as or otherwise support a means for establishing a connection with a UE, where the connection corresponds to a QoS flow for communications between the base station and the UE. The control signal transmission component 1030 may be configured as or otherwise support a means for transmitting, to the UE, control signaling including a configuration for the QoS flow in response to establishing the connection, where the configuration includes a set of one or more parameters specific to a direction of the QoS flow. The data communication component 1035 may be configured as or otherwise support a means for communicating data in the direction of the QoS flow in accordance with the set of one or more parameters.

In some examples, the set of one or more parameters includes a flow direction parameter configured to indicate the direction of the QoS flow. In some examples, the set of one or more parameters includes a QoS ID for the QoS flow, and the QoS direction component 1040 may be configured as or otherwise support a means for determining the direction of the QoS flow based on a mapping between the QoS ID and a QoS flow characteristic configured to indicate the direction.

In some examples, to support transmitting the control signaling, the connection establishment component 1025 may be configured as or otherwise support a means for transmitting the control signaling based on establishing the connection with the UE, an establishment of the QoS flow, a modification of the QoS flow, or any combination thereof.

In some examples, the set of one or more parameters comprise a first GFBR, a first MFBR, or both specific to an uplink direction in the QoS flow, and a second GFBR, a second MFBR, or both specific to a downlink direction in the QoS flow, and the data reception component 1045 may be configured as or otherwise support a means for receiving uplink data in the uplink direction of the QoS flow in accordance with the first GFBR, the first MFBR, or both. In some examples, to support communicating the data, the data transmission component 1050 may be configured as or otherwise support a means for transmitting downlink data in the downlink direction of the QoS flow in accordance with the second GFBR, the second MFBR, or both.

In some examples, the set of one or more parameters indicates an MDBV associated with the QoS flow, the MDBV corresponding to a bandwidth assumption for the QoS flow. In some examples, the first GFBR, the first MFBR, the second GFBR, the second MFBR, or any combination thereof override the bandwidth assumption.

In some examples, the set of one or more parameters indicates a GFBR of zero, an MFBR of zero, or both for one of an uplink direction or a downlink direction of the QoS flow. In some examples, the GFBR of zero, the MFBR of zero, or both for the one of the uplink direction or the downlink direction indicates the QoS flow is a unidirectional QoS flow.

In some examples, the set of one or more parameters indicates a first MDBV for each direction of the QoS flow and a second MDBV specific to a first direction of the QoS, and to support communicating the data, the MDBV component 1055 may be configured as or otherwise support a means for communicating the data in the first direction of the QoS flow in accordance with the second MDBV. In some examples, to support communicating the data, the MDBV component 1055 may be configured as or otherwise support a means for communicating the data in a second direction of the QoS flow in accordance with the first MDBV, where the first MDBV is a nominal value.

In some examples, the set of one or more parameters indicates the direction of the QoS is an uplink direction, and to support communicating the data, the data reception component 1045 may be configured as or otherwise support a means for receiving uplink data in the uplink direction of the QoS flow in accordance with the set of one or more parameters.

In some examples, the set of one or more parameters indicates the direction of the QoS is a downlink direction, and to support communicating the data, the data transmission component 1050 may be configured as or otherwise support a means for transmitting downlink data in the downlink direction of the QoS flow in accordance with the set of one or more parameters.

In some examples, the set of one or more parameters indicates the QoS supports an uplink direction and a downlink direction, and to support communicating the data, the data reception component 1045 may be configured as or otherwise support a means for receiving uplink data in the uplink direction of the QoS flow in accordance with the set of one or more parameters. In some examples, to support communicating the data, the data transmission component 1050 may be configured as or otherwise support a means for transmitting downlink data in the downlink direction of the QoS flow in accordance with the set of one or more parameters.

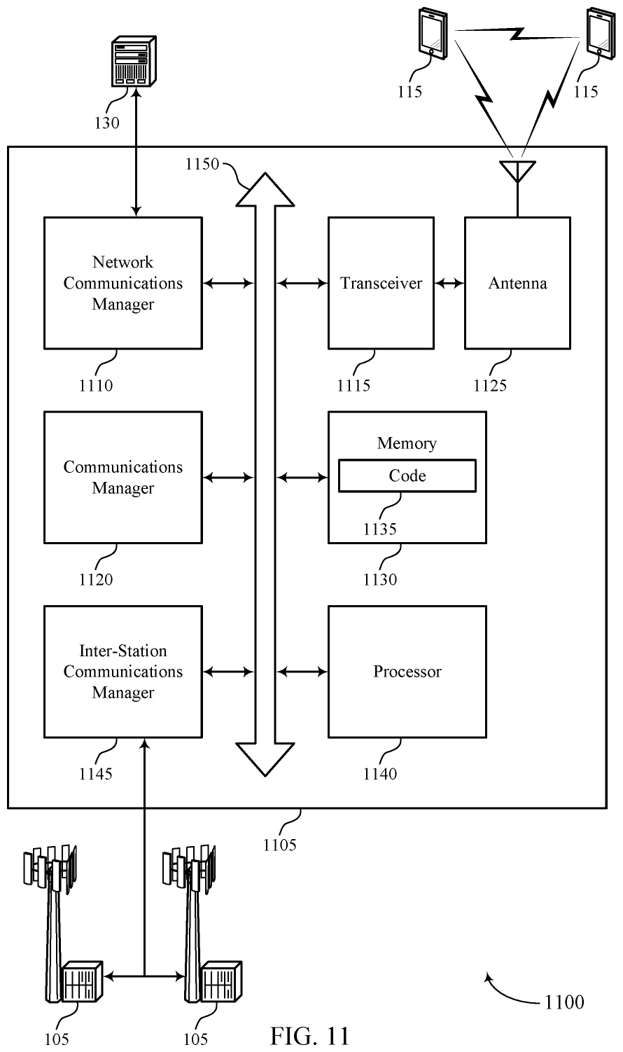

FIG. 11 shows a diagram of a system 1100 including a device 1105 that supports configuration for asymmetric QoS flows in accordance with aspects of the present disclosure. The device 1105 may be an example of or include the components of a device 805, a device 905, or a base station 105 as described herein. The device 1105 may communicate wirelessly with one or more base stations 105, UEs 115, or any combination thereof. The device 1105 may include components for bidirectional voice and data communications including components for transmitting and receiving communications, such as a communications manager 1120, a network communications manager 1110, a transceiver 1115, an antenna 1125, a memory 1130, code 1135, a processor 1140, and an inter-station communications manager 1145. These components may be in electronic communication or otherwise coupled (e.g., operatively, communicatively, functionally, electronically, electrically) via one or more buses (e.g., a bus 1150).

The network communications manager 1110 may manage communications with a core network 130 (e.g., via one or more wired backhaul links). For example, the network communications manager 1110 may manage the transfer of data communications for client devices, such as one or more UEs 115.

In some cases, the device 1105 may include a single antenna 1125. However, in some other cases the device 1105 may have more than one antenna 1125, which may be capable of concurrently transmitting or receiving multiple wireless transmissions. The transceiver 1115 may communicate bidirectionally, via the one or more antennas 1125, wired, or wireless links as described herein. For example, the transceiver 1115 may represent a wireless transceiver and may communicate bidirectionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include RAM and ROM. The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a BIOS which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting configuration for asymmetric QoS flows). For example, the device 1105 or a component of the device 1105 may include a processor 1140 and memory 1130 coupled to the processor 1140, the processor 1140 and memory 1130 configured to perform various functions described herein.

The inter-station communications manager 1145 may manage communications with other base stations 105, and may include a controller or scheduler for controlling communications with UEs 115 in cooperation with other base stations 105. For example, the inter-station communications manager 1145 may coordinate scheduling for transmissions to UEs 115 for various interference mitigation techniques such as beamforming or joint transmission. In some examples, the inter-station communications manager 1145 may provide an X2 interface within an LTE/LTE-A wireless communications network technology to provide communication between base stations 105.

The communications manager 1120 may support wireless communication at a base station in accordance with examples as disclosed herein. For example, the communications manager 1120 may be configured as or otherwise support a means for establishing a connection with a UE, where the connection corresponds to a QoS flow for communications between the base station and the UE. The communications manager 1120 may be configured as or otherwise support a means for transmitting, to the UE, control signaling including a configuration for the QoS flow in response to establishing the connection, where the configuration includes a set of one or more parameters specific to a direction of the QoS flow. The communications manager 1120 may be configured as or otherwise support a means for communicating data in the direction of the QoS flow in accordance with the set of one or more parameters.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of configuration for asymmetric QoS flows as described herein, or the processor 1140 and the memory 1130 may be otherwise configured to perform or support such operations.

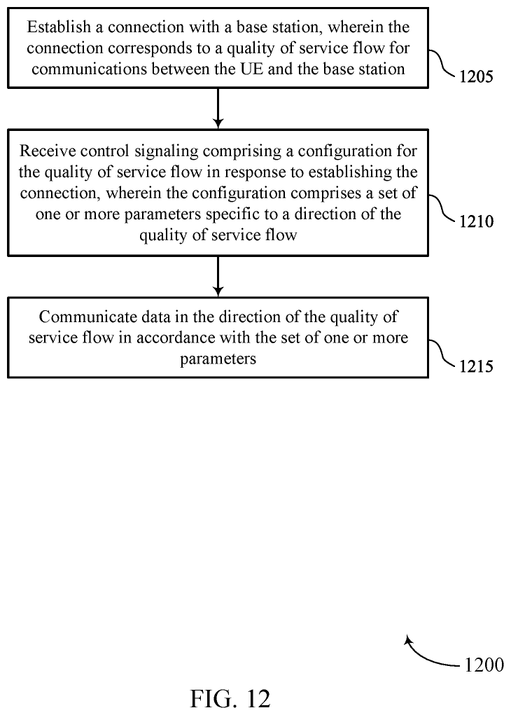

FIG. 12 shows a flowchart illustrating a method 1200 that supports configuration for asymmetric QoS flows in accordance with aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally or alternatively, the UE may perform aspects of the described functions using special-purpose hardware.

At 1205, the method may include establishing a connection with a base station, where the connection corresponds to a QoS flow for communications between the UE and the base station. The operations of 1205 may be performed in accordance with examples as disclosed herein. In some examples, aspects of the operations of 1205 may be performed by a connection establishment component 625 as described with reference to FIG. 6.

At 1210, the method may include receiving control signaling including a configuration for the QoS flow in response to establishing the connection, where the configuration includes a set of one or more parameters specific to a direction of the QoS flow. The operations of 1210 may be performed in accordance with examples as disclosed herein. In some examples, aspects of the operations of 1210 may be performed by a control signal reception component 630 as described with reference to FIG. 6.

At 1215, the method may include communicating data in the direction of the QoS flow in accordance with the set of one or more parameters. The operations of 1215 may be performed in accordance with examples as disclosed herein. In some examples, aspects of the operations of 1215 may be performed by a data communication component 635 as described with reference to FIG. 6.

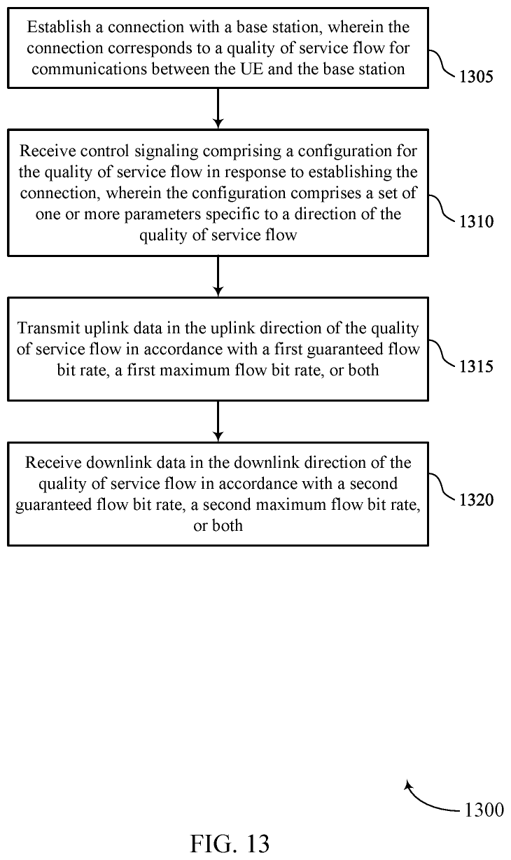

FIG. 13 shows a flowchart illustrating a method 1300 that supports configuration for asymmetric QoS flows in accordance with aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally or alternatively, the UE may perform aspects of the described functions using special-purpose hardware.

At 1305, the method may include establishing a connection with a base station, where the connection corresponds to a QoS flow for communications between the UE and the base station. The operations of 1305 may be performed in accordance with examples as disclosed herein. In some examples, aspects of the operations of 1305 may be performed by a connection establishment component 625 as described with reference to FIG. 6.

At 1310, the method may include receiving control signaling including a configuration for the QoS flow in response to establishing the connection, where the configuration includes a set of one or more parameters specific to a direction of the QoS flow. In some examples, the set of one or more parameters may include a first GFBR, a first MFBR, or both specific to an uplink direction of the QoS flow, and a second GFBR, a second MFBR, or both specific to a downlink direction of the QoS flow. The operations of 1310 may be performed in accordance with examples as disclosed herein. In some examples, aspects of the operations of 1310 may be performed by a control signal reception component 630 as described with reference to FIG. 6.

At 1315, the method may include transmitting uplink data in the uplink direction of the QoS flow in accordance with the first GFBR, the first MFBR, or both. The operations of 1315 may be performed in accordance with examples as disclosed herein. In some examples, aspects of the operations of 1315 may be performed by a data transmission component 645 as described with reference to FIG. 6.

At 1320, the method may include receiving downlink data in the downlink direction of the QoS flow in accordance with the second GFBR, the second MFBR, or both. The operations of 1320 may be performed in accordance with examples as disclosed herein. In some examples, aspects of the operations of 1320 may be performed by a data reception component 650 as described with reference to FIG. 6.

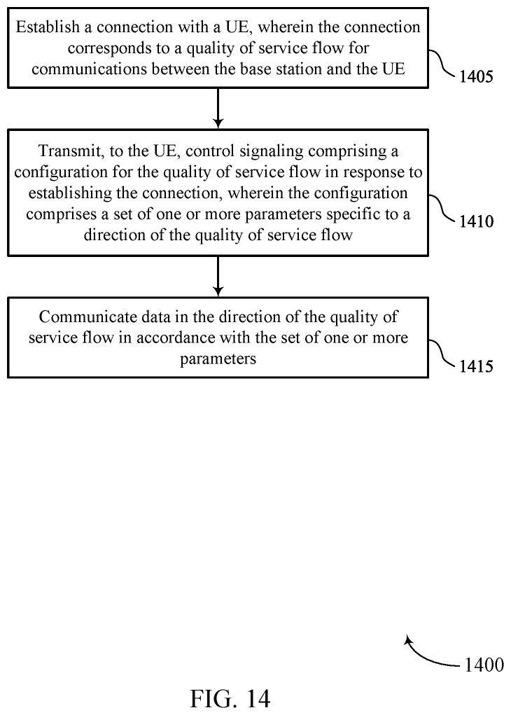

FIG. 14 shows a flowchart illustrating a method 1400 that supports configuration for asymmetric QoS flows in accordance with aspects of the present disclosure. The operations of the method 1400 may be implemented by a base station or its components as described herein. For example, the operations of the method 1400 may be performed by a base station 105 as described with reference to FIGS. 1 through 3 and 8 through 11. In some examples, a base station may execute a set of instructions to control the functional elements of the base station to perform the described functions. Additionally or alternatively, the base station may perform aspects of the described functions using special-purpose hardware.

At 1405, the method may include establishing a connection with a UE, where the connection corresponds to a QoS flow for communications between the base station and the UE. The operations of 1405 may be performed in accordance with examples as disclosed herein. In some examples, aspects of the operations of 1405 may be performed by a connection establishment component 1025 as described with reference to FIG. 10.

At 1410, the method may include transmitting, to the UE, control signaling including a configuration for the QoS flow in response to establishing the connection, where the configuration includes a set of one or more parameters specific to a direction of the QoS flow. The operations of 1410 may be performed in accordance with examples as disclosed herein. In some examples, aspects of the operations of 1410 may be performed by a control signal transmission component 1030 as described with reference to FIG. 10.

At 1415, the method may include communicating data in the direction of the QoS flow in accordance with the set of one or more parameters. The operations of 1415 may be performed in accordance with examples as disclosed herein. In some examples, aspects of the operations of 1415 may be performed by a data communication component 1035 as described with reference to FIG. 10.

The following provides an overview of aspects of the present disclosure:

Aspect 1: A method for wireless communication at a UE, comprising: establishing a connection with a base station, wherein the connection corresponds to a QoS flow for communications between the UE and the base station; receiving control signaling comprising a configuration for the QoS flow in response to establishing the connection, wherein the configuration comprises a set of one or more parameters specific to a direction of the QoS flow; and communicating data in the direction of the QoS flow in accordance with the set of one or more parameters.

Aspect 2: The method of aspect 1, wherein the set of one or more parameters comprises a flow direction parameter configured to indicate the direction of the QoS flow.

Aspect 3: The method of aspect 1, wherein the set of one or more parameters comprises a QoS ID for the QoS flow, the method further comprising: determining the direction of the QoS flow based at least in part on a mapping between the QoS flow ID and a QoS flow characteristic configured to indicate the direction.

Aspect 4: The method of any of aspects 1 through 3, wherein receiving the control signaling comprises: receiving the control signaling based at least in part on establishing the connection with the base station, an establishment of the QoS flow, a modification of the QoS flow, or any combination thereof.

Aspect 5: The method of any of aspects 1 through 4, wherein the set of one or more parameters comprises a first GFBR, a first MFBR, or both specific to an uplink direction in the QoS flow, and a second GFBR, a second MFBR, or both specific to a downlink direction in the QoS flow, and wherein communicating the data comprises: transmitting uplink data in the uplink direction of the QoS flow in accordance with the first GFBR, the first MFBR, or both; and receiving downlink data in the downlink direction of the QoS flow in accordance with the second GFBR, the second MFBR, or both.

Aspect 6: The method of aspect 5, wherein: the set of one or more parameters indicates an MDBV associated with the QoS flow, the MDBV corresponding to a bandwidth assumption for the QoS flow; and the first GFBR, the first MFBR, the second GFBR, the second MFBR, or any combination thereof override the bandwidth assumption.

Aspect 7: The method of any of aspects 1 through 6, wherein: the set of one or more parameters indicates a GFBR of zero, an MFBR of zero, or both for one of an uplink direction or a downlink direction of the QoS flow; and the GFBR of zero, the MFBR of zero, or both for the one of the uplink direction or the downlink direction indicates the QoS flow is a unidirectional QoS flow.

Aspect 8: The method of any of aspects 1 through 7, wherein the set of one or more parameters indicates a first MDBV for each direction of the QoS flow and a second MDBV specific to a first direction of the QoS flow, and wherein communicating the data comprises: communicating the data in the first direction of the QoS flow in accordance with the second MDBV; and communicating the data in a second direction of the QoS flow in accordance with the first MDBV, wherein the first MDBV is a nominal value.

Aspect 9: The method of any of aspects 1 through 8, wherein the set of one or more parameters indicates the direction of the QoS flow is an uplink direction, and wherein communicating the data comprises: transmitting uplink data in the uplink direction of the QoS flow in accordance with the set of one or more parameters.

Aspect 10: The method of any of aspects 1 through 8, wherein the set of one or more parameters indicates the direction of the QoS flow is a downlink direction, and wherein communicating the data comprises: receiving downlink data in the downlink direction of the QoS flow in accordance with the set of one or more parameters.

Aspect 11: The method of any of aspects 1 through 8, wherein the set of one or more parameters indicates the QoS flow supports an uplink direction and a downlink direction, and wherein communicating the data comprises: receiving downlink data in the downlink direction of the QoS flow in accordance with the set of one or more parameters; and transmitting uplink data in the uplink direction of the QoS flow in accordance with the set of one or more parameters.

Aspect 12: A method for wireless communication at a base station, comprising: establishing a connection with a UE, wherein the connection corresponds to a QoS flow for communications between the base station and the UE; transmitting, to the UE, control signaling comprising a configuration for the QoS flow in response to establishing the connection, wherein the configuration comprises a set of one or more parameters specific to a direction of the QoS flow; and communicating data in the direction of the QoS flow in accordance with the set of one or more parameters.

Aspect 13: The method of aspect 12, wherein the set of one or more parameters comprises a flow direction parameter configured to indicate the direction of the QoS flow.

Aspect 14: The method of aspect 12, wherein the set of one or more parameters comprises a QoS ID for the QoS flow, the method further comprising: determining the direction of the QoS flow based at least in part on a mapping between the QoS flow ID and a QoS flow characteristic configured to indicate the direction.

Aspect 15: The method of any of aspects 12 through 14, wherein transmitting the control signaling comprises: transmitting the control signaling based at least in part on establishing the connection with the UE, an establishment of the QoS flow, a modification of the QoS flow, or any combination thereof.

Aspect 16: The method of any of aspects 12 through 15, wherein the set of one or more parameters comprises a first GFBR, a first MFBR, or both specific to an uplink direction in the QoS flow, and a second GFBR, a second MFBR, or both specific to a downlink direction in the QoS flow, and wherein communicating the data comprises: receiving uplink data in the uplink direction of the QoS flow in accordance with the first GFBR, the first MFBR, or both; and transmitting downlink data in the downlink direction of the QoS flow in accordance with the second GFBR, the second MFBR, or both; and

Aspect 17: The method of aspect 16, wherein: the set of one or more parameters indicates an MDBV associated with the QoS flow, the MDBV corresponding to a bandwidth assumption for the QoS flow; and the first GFBR, the first MFBR, the second GFBR, the second MFBR, or any combination thereof override the bandwidth assumption.

Aspect 18: The method of any of aspects 12 through 17, wherein: the set of one or more parameters indicates a GFBR of zero, an MFBR of zero, or both for one of an uplink direction or a downlink direction of the QoS flow; and the GFBR of zero, the MFBR of zero, or both for the one of the uplink direction or the downlink direction indicates the QoS flow is a unidirectional QoS flow.

Aspect 19: The method of any of aspects 12 through 18, wherein the set of one or more parameters indicates a first MDBV for each direction of the QoS flow and a second MDBV specific to a first direction of the QoS flow, and wherein communicating the data comprises: communicating the data in the first direction of the QoS flow in accordance with the second MDBV; and communicating the data in a second direction of the QoS flow in accordance with the first MDBV, wherein the first MDBV is a nominal value.

Aspect 20: The method of any of aspects 12 through 19, wherein the set of one or more parameters indicates the direction of the QoS flow is an uplink direction, and wherein communicating the data comprises: receiving uplink data in the uplink direction of the QoS flow in accordance with the set of one or more parameters.

Aspect 21: The method of any of aspects 12 through 19, wherein the set of one or more parameters indicates the direction of the QoS flow is a downlink direction, and wherein communicating the data comprises: transmitting downlink data in the downlink direction of the QoS flow in accordance with the set of one or more parameters.

Aspect 22: The method of any of aspects 12 through 19, wherein the set of one or more parameters indicates the QoS flow supports an uplink and a downlink directions, and wherein communicating the data comprises: receiving uplink data in the uplink direction of the QoS flow in accordance with the set of one or more parameters; and transmitting downlink data in the downlink direction of the QoS flow in accordance with the set of one or more parameters.

Aspect 23: An apparatus for wireless communication at a UE, comprising a processor; memory coupled with the processor; and instructions stored in the memory and executable by the processor to cause the apparatus to perform a method of any of aspects 1 through 11.

Aspect 24: An apparatus for wireless communication at a UE, comprising at least one means for performing a method of any of aspects 1 through 11.

Aspect 25: A non-transitory computer-readable medium storing code for wireless communication at a UE, the code comprising instructions executable by a processor to perform a method of any of aspects 1 through 11.

Aspect 26: An apparatus for wireless communication at a base station, comprising a processor; memory coupled with the processor; and instructions stored in the memory and executable by the processor to cause the apparatus to perform a method of any of aspects 12 through 22.

Aspect 27: An apparatus for wireless communication at a base station, comprising at least one means for performing a method of any of aspects 12 through 22.

Aspect 28: A non-transitory computer-readable medium storing code for wireless communication at a base station, the code comprising instructions executable by a processor to perform a method of any of aspects 12 through 22.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a processor;
memory coupled with the processor; and
instructions stored in the memory and executable by the processor to cause the apparatus to:
establish a connection with a base station, wherein the connection corresponds to a quality of service flow for communications between the UE and the base station;
receive control signaling comprising a configuration for the quality of service flow in response to establishing the connection, wherein the configuration comprises a set of one or more parameters specific to a direction of the quality of service flow; and
communicate data in the direction of the quality of service flow in accordance with the set of one or more parameters.

2. The apparatus of claim 1, wherein the set of one or more parameters comprises a flow direction parameter configured to indicate the direction of the quality of service flow.

3. The apparatus of claim 1, wherein the set of one or more parameters comprises a quality of service identifier for the quality of service flow, and wherein the instructions are further executable by the processor to cause the apparatus to:
determine the direction of the quality of service flow based at least in part on a mapping between the quality of service identifier and a quality of service flow characteristic configured to indicate the direction.

4. The apparatus of claim 1, wherein the instructions to receive the control signaling are executable by the processor to cause the apparatus to:
receive the control signaling based at least in part on establishing the connection with the base station, an establishment of the quality of service flow, a modification of the quality of service flow, or any combination thereof.

5. The apparatus of claim 1, wherein the set of one or more parameters comprise a first guaranteed flow bit rate, a first maximum flow bit rate, or both specific to an uplink direction in the quality of service flow, and a second guaranteed flow bit rate, a second maximum flow bit rate, or both specific to a downlink direction in the quality of service flow, and wherein the instructions to communicate the data are executable by the processor to cause the apparatus to:
transmit uplink data in the uplink direction of the quality of service flow in accordance with the first guaranteed flow bit rate, the first maximum flow bit rate, or both; and
receive downlink data in the downlink direction of the quality of service flow in accordance with the second guaranteed flow bit rate, the second maximum flow bit rate, or both.

6. The apparatus of claim 5, wherein:
the set of one or more parameters indicates a maximum data burst volume associated with the quality of service flow, the maximum data burst volume corresponding to a bandwidth assumption for the quality of service flow; and
the first guaranteed flow bit rate, the first maximum flow bit rate, the second guaranteed flow bit rate, the second maximum flow bit rate, or any combination thereof override the bandwidth assumption.

7. The apparatus of claim 1, wherein:
the set of one or more parameters indicates a guaranteed flow bit rate of zero, a maximum flow bit rate of zero, or both for one of an uplink direction or a downlink direction of the quality of service flow; and
the guaranteed flow bit rate of zero, the maximum flow bit rate of zero, or both for the one of the uplink direction or the downlink direction indicates the quality of service flow is a unidirectional quality of service flow.

8. The apparatus of claim 1, wherein the set of one or more parameters indicates a first maximum data burst volume for each direction of the quality of service flow and a second maximum data burst volume specific to a first direction of the quality of service flow, and wherein the instructions to communicate the data are executable by the processor to cause the apparatus to:
communicate the data in the first direction of the quality of service flow in accordance with the second maximum data burst volume; and
communicate the data in a second direction of the quality of service flow in accordance with the first maximum data burst volume, wherein the first maximum data burst volume is a nominal value.

9. The apparatus of claim 1, wherein the set of one or more parameters indicates the direction of the quality of service flow is an uplink direction, and wherein the instructions to communicate the data are executable by the processor to cause the apparatus to:
transmit uplink data in the uplink direction of the quality of service flow in accordance with the set of one or more parameters.

10. The apparatus of claim 1, wherein the set of one or more parameters indicates the direction of the quality of service flow is a downlink direction, and wherein the instructions to communicate the data are executable by the processor to cause the apparatus to:
receive downlink data in the downlink direction of the quality of service flow in accordance with the set of one or more parameters.

11. The apparatus of claim 1, wherein the set of one or more parameters indicates the quality of service flow supports an uplink direction and a downlink direction, and wherein the instructions to communicate the data are executable by the processor to cause the apparatus to:
receive downlink data in the downlink direction of the quality of service flow in accordance with the set of one or more parameters; and
transmit uplink data in the uplink direction of the quality of service flow in accordance with the set of one or more parameters.

12. An apparatus for wireless communication at a base station, comprising:
a processor;
memory coupled with the processor; and
instructions stored in the memory and executable by the processor to cause the apparatus to:
establish a connection with a user equipment (UE), wherein the connection corresponds to a quality of service flow for communications between the base station and the UE;
transmit, to the UE, control signaling comprising a configuration for the quality of service flow in response to establishing the connection, wherein the configuration comprises a set of one or more parameters specific to a direction of the quality of service flow; and
communicate data in the direction of the quality of service flow in accordance with the set of one or more parameters.

13. The apparatus of claim 12, wherein the set of one or more parameters comprises a flow direction parameter configured to indicate the direction of the quality of service flow.

14. The apparatus of claim 12, wherein the set of one or more parameters comprises a quality of service identifier for the quality of service flow, and wherein the instructions are further executable by the processor to cause the apparatus to:
determine the direction of the quality of service flow based at least in part on a mapping between the quality of service identifier and a quality of service flow characteristic configured to indicate the direction.

15. The apparatus of claim 12, wherein the instructions to transmit the control signaling are executable by the processor to cause the apparatus to:
transmit the control signaling based at least in part on establishing the connection with the UE, an establishment of the quality of service flow, a modification of the quality of service flow, or any combination thereof.

16. The apparatus of claim 12, wherein the set of one or more parameters comprises a first guaranteed flow bit rate, a first maximum flow bit rate, or both specific to an uplink direction in the quality of service flow, and a second guaranteed flow bit rate, a second maximum flow bit rate, or both specific to a downlink direction in the quality of service flow, and wherein the instructions to communicate the data are executable by the processor to cause the apparatus to:
receive uplink data in the uplink direction of the quality of service flow in accordance with the first guaranteed flow bit rate, the first maximum flow bit rate, or both; and
transmit downlink data in the downlink direction of the quality of service flow in accordance with the second guaranteed flow bit rate, the second maximum flow bit rate, or both.

17. The apparatus of claim 16, wherein:
the set of one or more parameters indicates a maximum data burst volume associated with the quality of service flow, the maximum data burst volume corresponding to a bandwidth assumption for the quality of service flow; and
the first guaranteed flow bit rate, the first maximum flow bit rate, the second guaranteed flow bit rate, the second maximum flow bit rate, or any combination thereof override the bandwidth assumption.

18. The apparatus of claim 12, wherein:
the set of one or more parameters indicates a guaranteed flow bit rate of zero, a maximum flow bit rate of zero, or both for one of an uplink direction or a downlink direction of the quality of service flow; and
the guaranteed flow bit rate of zero, the maximum flow bit rate of zero, or both for the one of the uplink direction or the downlink direction indicates the quality of service flow is a unidirectional quality of service flow.

19. The apparatus of claim 12, wherein the set of one or more parameters indicates a first maximum data burst volume for each direction of the quality of service flow and a second maximum data burst volume specific to a first direction of the quality of service flow, and wherein the instructions to communicate the data are executable by the processor to cause the apparatus to:
communicate the data in the first direction of the quality of service flow in accordance with the second maximum data burst volume; and
communicate the data in a second direction of the quality of service flow in accordance with the first maximum data burst volume, wherein the first maximum data burst volume is a nominal value.

20. The apparatus of claim 12, wherein the set of one or more parameters indicates the direction of the quality of service flow is an uplink direction, and wherein the instructions to communicate the data are executable by the processor to cause the apparatus to:
receive uplink data in the uplink direction of the quality of service flow in accordance with the set of one or more parameters.

21. The apparatus of claim 12, wherein the set of one or more parameters indicates the direction of the quality of service flow is a downlink direction, and wherein the instructions to communicate the data are executable by the processor to cause the apparatus to:
transmit downlink data in the downlink direction of the quality of service flow in accordance with the set of one or more parameters.

22. The apparatus of claim 12, wherein the set of one or more parameters indicates the quality of service flow supports an uplink direction and a downlink direction, and wherein the instructions to communicate the data are executable by the processor to cause the apparatus to:
receive uplink data in the uplink direction of the quality of service flow in accordance with the set of one or more parameters; and
transmit downlink data in the downlink direction of the quality of service flow in accordance with the set of one or more parameters.

23. A method for wireless communication at a user equipment (UE), comprising:
establishing a connection with a base station, wherein the connection corresponds to a quality of service flow for communications between the UE and the base station;
receiving control signaling comprising a configuration for the quality of service flow in response to establishing the connection, wherein the configuration comprises a set of one or more parameters specific to a direction of the quality of service flow; and
communicating data in the direction of the quality of service flow in accordance with the set of one or more parameters.

24. The method of claim 23, wherein the set of one or more parameters comprises a flow direction parameter configured to indicate the direction of the quality of service flow.

25. The method of claim 23, wherein the set of one or more parameters comprises a quality of service identifier for the quality of service flow, the method further comprising:
determining the direction of the quality of service flow based at least in part on a mapping between the quality of service identifier and a quality of service flow characteristic configured to indicate the direction.

26. The method of claim 23, wherein receiving the control signaling comprises:
receiving the control signaling based at least in part on establishing the connection with the base station, an establishment of the quality of service flow, a modification of the quality of service flow, or any combination thereof.

27. The method of claim 23, wherein the set of one or more parameters comprises a first guaranteed flow bit rate, a first maximum flow bit rate, or both specific to an uplink direction in the quality of service flow, and a second guaranteed flow bit rate, a second maximum flow bit rate, or both specific to a downlink direction in the quality of service flow, and wherein communicating the data comprises:
transmitting uplink data in the uplink direction of the quality of service flow in accordance with the first guaranteed flow bit rate, the first maximum flow bit rate, or both; and
receiving downlink data in the downlink direction of the quality of service flow in accordance with the second guaranteed flow bit rate, the second maximum flow bit rate, or both.

28. A method for wireless communication at a base station, comprising:
establishing a connection with a user equipment (UE), wherein the connection corresponds to a quality of service flow for communications between the base station and the UE;
transmitting, to the UE, control signaling comprising a configuration for the quality of service flow in response to establishing the connection, wherein the configuration comprises a set of one or more parameters specific to a direction of the quality of service flow; and
communicating data in the direction of the quality of service flow in accordance with the set of one or more parameters.

29. The method of claim 28, wherein the set of one or more parameters comprises a flow direction parameter configured to indicate the direction of the quality of service flow.

30. The method of claim 28, wherein the set of one or more parameters comprises a quality of service identifier for the quality of service flow, the method further comprising:
determining the direction of the quality of service flow based at least in part on a mapping between the quality of service identifier and a quality of service flow characteristic configured to indicate the direction.
